(19) United States
(12) Patent Application Publication
(10) Pub. No.: US 2024/0328479 A1
(43) Pub. Date: Oct. 3, 2024

(54) Decoupling Device

(71) Applicant: SUMITOMO RIKO COMPANY LIMITED, Aichi (JP)

(72) Inventors: Malek LANG, Steinau (DE); Youssef IRAKI, Hanau (DE); Martin GROMES, Steinau (DE)

(21) Appl. No.: 18/589,653

(22) Filed: Feb. 28, 2024

(30) Foreign Application Priority Data
Mar. 29, 2023 (DE) 10 2023 107 980.8

(51) Int. Cl. F16F 15/04

(52) U.S. Cl. CPC F16F 15/04

(57) ABSTRACT

A decoupling device is disclosed for connecting a component which vibrates during operation to an environment. The decoupling device comprises a bracket arrangement and a damping arrangement, and a fixing geometry and a stop geometry. The stop geometry is equipped with multiple stops which are arranged at an offset with respect to each other in the direction of the cylinder axis of the decoupling device.

### CROSS-REFERENCE TO RELATED APPLICATIONS

This application claims the priority of German patent application DE 10 2023 107 980.8, filed Mar. 29, 2023, the entire content of which is hereby incorporated by reference.

### FIELD

The present disclosure relates to a decoupling device for connecting a component which vibrates during operation, for example a compressor, to an environment, for example a vehicle body, wherein a bracket for holding the component and a damping arrangement for damping vibrations and/or movements of the component are provided. A fixing geometry is also designed for fixing the decoupling device to the environment, and a stop geometry comprising multiple stops is arranged for limiting maximum oscillations permitted for the damping arrangement, in particular due to the vibrations and/or movements of the component.

### BACKGROUND

A decoupling device which connects a component to an environment of the component is known for example from DE 10 2020 126 561 B4.

Such a decoupling device usually has to be inserted into a very limited installation space. Since drastic space limitations have to be observed due to the limited installation space, the prior art uses small material layer thicknesses for damping materials and stops which are intended to prevent excessive stress on the damping materials are often utilized in the disc-shaped prior-art decoupling devices, since the damping by the damping materials provided is only slight. As a result, the decoupling and/or damping by the prior-art decoupling devices leaves much to be desired, and the service life of the known decoupling devices is also significantly reduced by excessive stress on the damping materials.

### SUMMARY

An object of the embodiments of the present disclosure is to provide a decoupling device which can be adapted to a small installation space and which enables the component to be advantageously decoupled from its environment, despite the limited space available.

Such a decoupling device in accordance with an embodiment includes multiple stops for limiting the vibrations and/or movements of the component and comprises at least one stop within the stop geometry which is offset in the vertical direction and/or in the direction of the cylinder axis of the preferably cylindrical decoupling device relative to another stop of the stop geometry. The stops are at least partially produced from an elastomer and/or rubber or the like.

Because the decoupling device in accordance with the present embodiments extends in the direction of the cylinder axis of the decoupling device, the stops of the stop geometry can be drawn apart in the direction of the cylinder axis of the decoupling device, i.e. as soon as the decoupling device in accordance with the embodiments is positioned upright in its installed position, the stops are drawn apart and/or mutually offset in the vertical direction. On the one hand, this provides more space in order to produce the damping material of the damping arrangement with a greater input of material, such that vibrations and/or movements of the component can be better decoupled from the environment, such as a vehicle body, and/or better damped relative to said environment. The stops which are mutually offset in the direction of the cylinder axis can also be accommodated in the installation space in a direction other than a plane and/or the horizontal, which would otherwise remain unused.

Accordingly, the damping arrangement of the decoupling device is elongated in the axial direction of the decoupling device. The prior-art decoupling devices are designed more in the horizontal direction and/or in a plane, if they hold and/or support the installed component in the vertical direction. Consequently, it is advantageously possible in accordance with the present embodiments for the damping arrangement to be more massive, such that the decoupling and damping function can be substantially better performed, wherein the stops which in accordance with the invention are mutually offset in the direction of the cylinder axis of the preferably cylindrical decoupling device can absorb excessive stresses on the damping arrangement and/or damping material.

A compressor in a vehicle can for example be supported via one or more decoupling devices in accordance with the invention. Depending on the output of the compressor, the one or more decoupling devices according to the invention would then have to decouple and/or damp approximately 10 to 35 N/mm relative to the vehicle.

Accordingly, the decoupling device in accordance with an embodiment may preferably embodied to comprise two or more stages which comprise the damping arrangement and to which respective mutually offset and/or staggered stops are assigned, i.e., the stops of the stop geometry are advantageously positioned axially one above the other and functionally relative to the stages of the damping arrangement.

The fixing geometry preferably comprises at least one fixing element, such as a screw bolt or the like which extends vertically along the cylinder axis and as applicable in the installed position, around which the decoupling device at least partially extends cylindrically, wherein the fixing element corresponds to the cylinder axis.

In accordance with an embodiment, the fixing element can preferably be accommodated in an encasing element which comprises an at least partially and in particular circumferentially continuous damping and/or decoupling layer which extends in the axial direction along and around the fixing element, wherein a casing which is formed from a hard and resistant material, such as aluminum, steel or hard plastic, is provided between the fixing element and the damping and/or decoupling layer, which also forms stops.

The decoupling device in accordance with an embodiment advantageously exhibits a design in which it comprises circumferential bulges in the functional position which are staggered in the axial direction and correspond at least functionally to the axially offset stops of the stop geometry with respect to their position which is offset in the axial direction.

In the installed position in an environment, such as a vehicle, the component to be assembled (the vibrations and/or movements of which during operation are to be decoupled and/or damped) is mounted in the vertical direction on the decoupling device in accordance with one or more of the embodiments with respect to its load and/or weight. In this installed position, the decoupling device generally extends cylindrically in the vertical direction, i.e., the decoupling device in accordance with the invention is substantially cylindrical in its main direction of extension. Conversely, it is of course also possible, with certain modifications, to install the decoupling device in accordance with the invention not vertically or approximately vertically but rather aligned in other directions with respect to its cylinder axis, if the installation space available in the environment, such as a vehicle body, requires this.

The present disclosure explains in more detail below on the basis of preferred embodiments by referring to the attached figures, wherein constituent parts shown in the figures are denoted by the same reference signs throughout, such that repeated descriptions of identical constituent parts can be omitted.

### BRIEF DESCRIPTION OF THE DRAWINGS

FIG. 1 shows a sectional view of a decoupling device of an embodiment;

FIG. 2 shows a plan view of the embodiment in accordance with FIG. 1;

FIG. 3 shows an embodiment in a sectional view tilted into the horizontal;

FIG. 4 shows a perspective view of an assembly arrangement for assembling a decoupling device in accordance with an embodiment in a simplified way;

FIGS. 5a to 5c show respective perspective plan views of the individual constituent parts of the arrangement in accordance with FIG. 4;

FIGS. 6a and 6b show the assembly arrangement in accordance with FIGS. 4 to 5c with respect to its position relative to an encasing element which is also referred to below as a stepped collar bushing; and

FIGS. 7a and 7b show a decoupling device in accordance with an embodiment in a sectional view along the Z axis, respectively offset by 90° to each other.

### DETAILED DESCRIPTION

FIG. 1 shows an embodiment of a decoupling device in a sectional view along the cylinder axis Z. A main direction of extension of a stepped collar bushing 12 likewise extends in the direction of the cylinder axis Z, which can as applicable also represent the vertical or an intermediate angle between the horizontal and the vertical when the decoupling device in accordance with the invention is in its installed position. The reference sign 13 denotes an assembly portion which comprises multiple constituent parts which can be fitted together such that they are latched together. The constituent parts of the assembly portion can be formed from a resistant plastic.

The stepped collar bushing 12 comprises a casing 14 made of a resistant material which assists in decoupling. A material which can be used for the casing 14 can be selected from the range of metals such as aluminum, steel or the like, or a hard plastic material. The casing 14 of the stepped collar bushing 12 can for example be manufactured from a hard plastic or metal, in particular aluminum, onto which stops 16, 18 made of a soft, resilient material, such as an elastomer and/or rubber, can be injection-molded.

A bushing radial stop 16 and another bushing radial stop 16a are provided at an offset relative to an axial support 17. The stops 16, 16a can absorb vibrations, wherein the material of the decoupling region 38, which likewise assists in damping, is also then not subjected to excessive stress and therefore does not or hardly ages.

In the regions of the stops, the design in accordance with the embodiments enables stepped and therefore voluminous casing regions 14a, 14b to be provided which exhibit a larger diameter than the average diameter of the casing 14. This provides the advantages of better damping and reduced aging, since the stops 16, 18 in these casing regions 14a, 14b can likewise be equipped with greater amounts of material.

An axial stop 18 and an axial additional stop 20 in combination with an additional bushing axial stop 22 co-operate in accordance with the invention in order on the one hand to advantageously enable vibrations and/or movements of a component to be decoupled and therefore damped and on the other hand to not cause excessively rapid aging of the damping material.

The reference sign 24 denotes an environment, for example a part of a vehicle body, via which the decoupling device 10 in accordance with the invention is fixed to the environment 24 in an assembly opening 28 by means of a fixing device 26, which comprises a fastener such as a screw bolt, wherein a damping body 30 likewise serves the purpose of decoupling, but need not be formed integrally from a piece of damping material, but rather can also be constructed from a resilient structure, for example a rib-like structure, made of a rather firm plastic material. It will be appreciated that the fastener can comprise any suitable type of fastener.

In combination with the assembly portion 13, a latching arrangement 34 facilitates combining the individual constituent parts of the decoupling device. A radial extra stop 36 can co-operate with the bushing radial stop 16 and the other bushing radial stop 16a.

Constituent parts which are assigned to the assembly portion 13 can be manufactured from metal, preferably aluminum, and/or a hard plastic material.

A connector arrangement 52, which can likewise be cylindrical, includes the group constituent parts of the decoupling device and enables them to be assembled in a simplified way. It can be regarded as a radial housing for the decoupling device 10.

In accordance with the embodiment of FIG. 1, it can be seen that the stops 16, 18, 20, 22 and 36 are mutually offset in the direction of the cylinder axis Z, such that more space is available for providing installation space for damping material for the purpose of decoupling and/or damping. It is therefore possible to avoid the problem that due to a small installation space, less damping material is arranged in excessively thin layers, and which is also subjected to excessive stress by substantial vibrations and/or percussive movements of the component to be fixed. It is thus possible to avoid excessively rapid aging of the decoupling device 10.

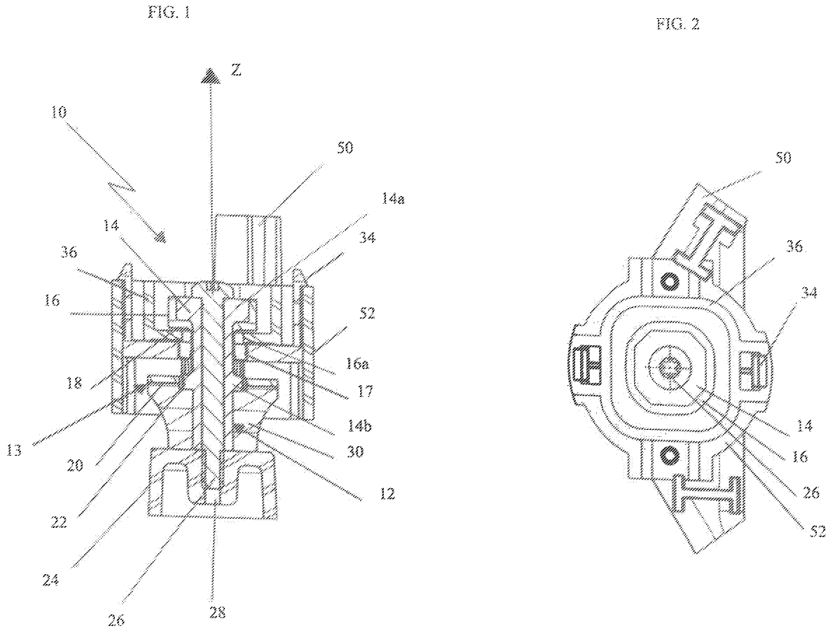

FIG. 2 shows an installation bracket 50 which comprises a connector arrangement 52 which fixes a component to be fixed (not shown) to the environment and/or vehicle body via the decoupling device 10.

In the plan view shown, corresponding constituent parts in accordance with the FIG. 1 embodiment are shown.

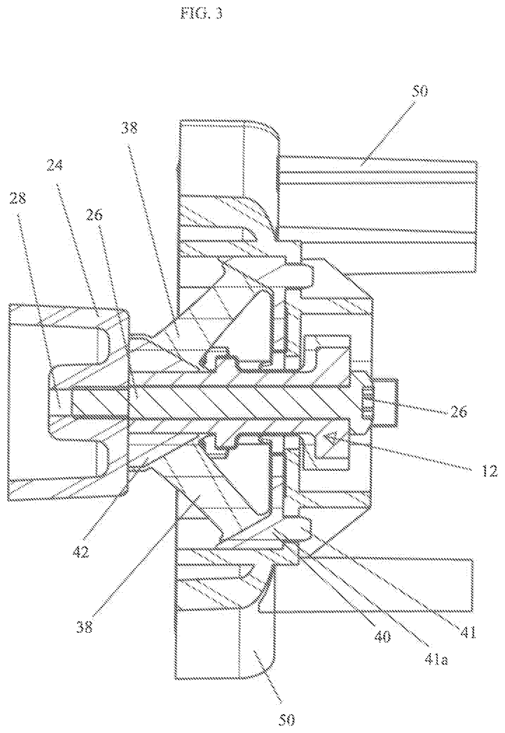

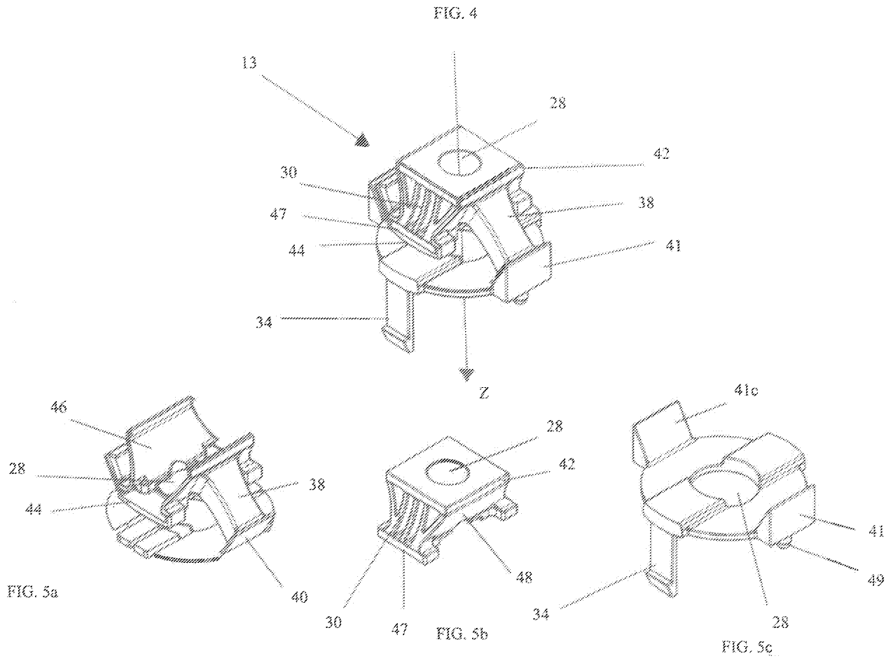

FIG. 3 shows the damping body 30 in a position which is rotated by 90° relative to the position shown in FIG. 1. In this orientation which is rotated by 90°, a decoupling region 38 is shown which can be embodied as a suspension spring made of an elastomer. This decoupling region 38 adjoins a bearing support 21 via a bearing surface 41a.

A base region 42 is assigned to the environment and/or vehicle body 24.

FIG. 3 shows a modified embodiment, but not in a vertical installed position but rather in an installed position in which the decoupling device 10 is assembled in a horizontal installed position.

FIG. 4 shows an assembly portion 13, such as can for example be used in the embodiment in accordance with FIGS. 1 and 2 and/or 3. For orientation, the cylinder axis Z is shown as in FIG. 1. A connecting body 47 is accommodated in a shoe portion 44, wherein in accordance with FIG. 5a, an abutment region 46 is provided which is brought into abutment with a bearing region 48 in accordance with FIG. 5b when the individual constituent parts are combined in accordance with FIGS. 5a and 5b.

Another assembly portion in accordance with FIG. 5c comprises a centering geometry 49 which is intended to facilitate assembling the individual constituent parts and arranging them with respect to each other when assembling them. The constituent part in accordance with FIG. 5c comprises the latching arrangement 34, by means of which the assembly arrangement 13 is fixed in the connector arrangement 52 in accordance with FIGS. 1 and 2 and/or 3, in order to enable the constituent parts to be pre-assembled, which can be ultimately completed by introducing the fixing device 26 and/or screw bolt 26.

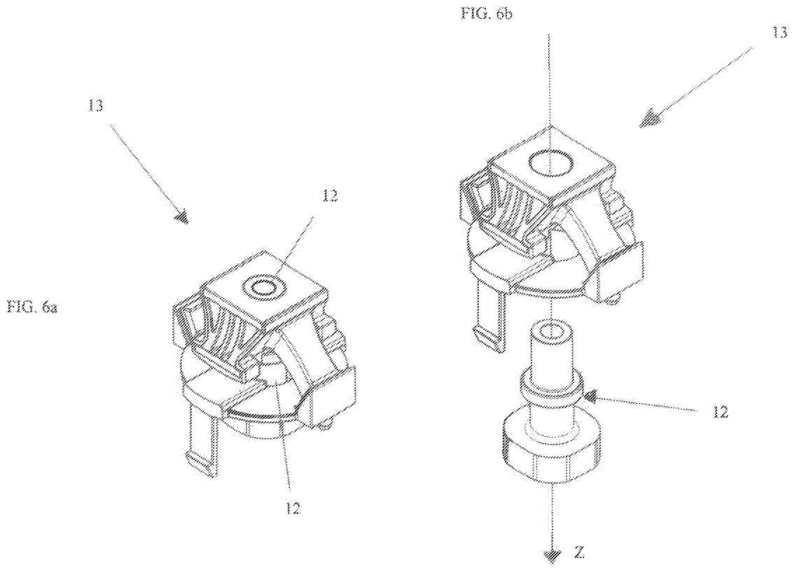

FIGS. 6a and 6b show how the encasing element (in this case, the stepped collar bushing 12) is introduced and/or assembled in relation to the assembly portion 13. The stepped collar bushing 12 can be seen to comprise both the casing 14, made of a hard and resistant material, and constituent parts of the stop geometry comprising axial stops and radial stops. The assembly arrangement can also be embodied to comprise stops, which can however be more easily seen from the figures described above.

Referring to FIG. 1, it can be seen that a vibrating component, for example a compressor of an air-conditioning system (not shown), is assembled on the connector arrangement 52 via the installation bracket 50. The connector arrangement 52 for its part accommodates within itself the decoupling device 10 in accordance with the invention which is fixed to the vehicle body 24 in the assembly opening 28, which can be equipped with an internal thread, via the screw bolt 26.

Vibrations which are generated for example by a compressor are compensated for by the stops 16, 16a, 18, 20 of the stepped collar bushing 12. The vibrations lead to a radial oscillation which can vary substantially due to the movements of the vehicle, but also due to the vibration spectrum of the compressor. Excessive stress on the decoupling device 10 may occur due to excessive oscillations if the excessive oscillations were not absorbed by the radially acting stops 16, 16a, 20, 36.

The same applies to oscillations in the axial direction Z, i.e., along the cylinder axis Z of the substantially cylindrical decoupling device 10 in accordance with the invention. Axial oscillations can be decoupled by the axially acting stops 18, 20 and by the damping body 30. Excessive axial oscillations are limited by the axially acting stops 18, 20.

The limited installation space available in a vehicle can be used for more damping material which can better absorb vibrations. The axially offset stops expand the installation space available for the damping material.

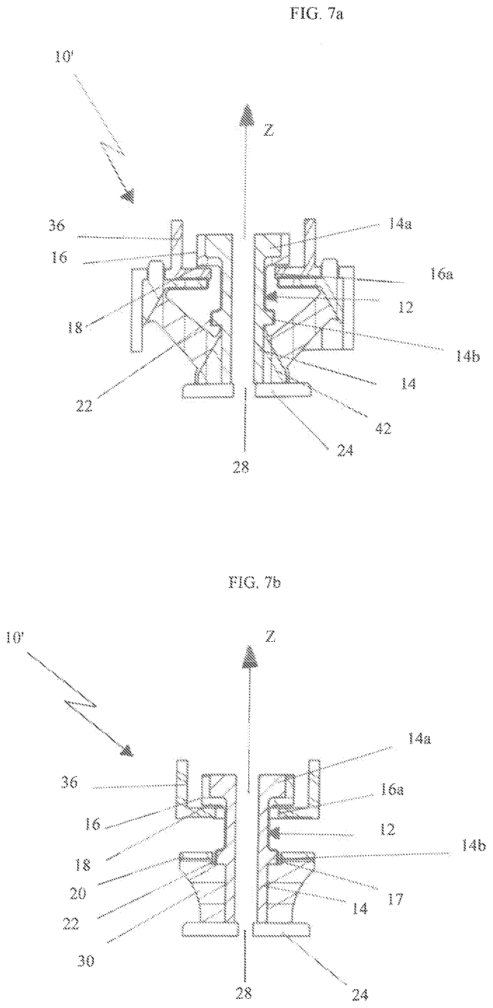

FIGS. 7a and 7b show another embodiment of the decoupling device 10′ in two sectional views which are rotated about the Z axis by 90° with respect to each other, wherein only constituent parts which are relevant to decoupling and/or damping are illustrated.

As shown in FIG. 7a, the decoupling device 10′ is again placed onto an environment 24, and an assembly opening 28 enables it to be fixed to said environment 24.

Radially acting stops 16, 16a, 22, 36 preferably decouple vibrations of an assembled component (not shown). The additional bushing axial stop 22 has no complementary stop in this orientation of the section through the decoupling device, but is retained by a radial additional stop 20 in accordance with FIG. 7b.

The encasing element 12 (called a stepped collar bushing 12 in this case) can clearly be seen to be equipped with a casing 14 which, due to its stepped structure in the region of the stops 16, 18, 22, can be embodied to comprise particularly voluminous casing regions 16a, 16b of the casing 14, i.e. more of the elastic material can be provided for the stops 16, 18, 20 for absorbing excessive impact energy in the regions where such impacts are more likely, which both improves the decoupling properties and minimizes aging.

Axial stops act in the axial direction Z, such as the axial stop 18 and the additional bushing axial stop 22 in its functional position shown in FIG. 7b.

Constituent parts assigned to assembling are less relevant and are not described here, since they can also be embodied differently. The decoupling device 10′ rests against the environment 24 via a base region 42.

FIG. 7b additionally shows in particular a damping body 30 which supports an axial additional stop 20 which adjoins the axial support 17 and co-operates with the additional bushing axial stop 22 in the axial Z direction.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

10, 10′ decoupling device
12 stepped collar bushing, encasing element
13 assembly portion
14 casing
14a, 14b casing region
16 bushing radial stop
16a other bushing radial stop
17 axial support
18 axial stop
20 axial additional stop
22 additional bushing axial stop
24 environment, vehicle body
26 fixing device, screw bolt
28 assembly opening
30 damping body
34 latching arrangement
36 radial extra stop
38 decoupling region
40 connector portion
41 bearing support
41a bearing surface
42 base region
44 shoe portion
46 abutment region
47 connecting body
48 bearing region
49 centering geometry
50 installation bracket
52 connector arrangement

1. A decoupling device for connecting a component to an environment, such as a vehicle body, comprising:
a bracket for holding the component;
a damping arrangement for damping vibrations or movements or both of the component;
a fixing geometry for fixing the decoupling device to the environment; and
a stop geometry comprising multiple stops for limiting maximum oscillations permitted for the damping arrangement, wherein t at least one stop of the stop geometry is offset in the direction of the cylinder axis (Z) relative to another stop of the stop geometry.

2. The decoupling device according to claim 1, wherein the damping arrangement is elongated in the direction of the cylinder axis (Z).

3. The decoupling device according to claim 1, wherein the damping arrangement comprises two or more stages which are arranged one above the other in a direction of the cylinder axis (Z).

4. The decoupling device according to claim 3, wherein the stops of the stop geometry are at least partially arranged axially one above the other and functionally relative to the stages of the damping arrangement.

5. The decoupling device according to claim 1, wherein the fixing geometry comprises at least one fixing device, around which the decoupling device extends at least approximately cylindrically, wherein the fixing device corresponds to the cylinder axis (Z) of the decoupling device.

6. The decoupling device according to claim 1, wherein the fixing device is accommodated in an encasing element which comprises an at least partially and in particular circumferentially continuous casing which extends in the direction of the cylinder axis (Z) at least partially along the fixing device.

7. The decoupling device according to claim 6, wherein the casing (14) comprises circumferentially bulging casing regions which are staggered in the direction of the cylinder axis (Z) and which at least functionally correspond to the axially offset stops of the stop geometry with respect to their positions offset in the direction of the cylinder axis (Z).

8. The decoupling device according to claim 7, wherein more damping material is arranged at the casing regions than at other regions.

9. The decoupling device according to claim 8, wherein an accumulation of stops are provided near and/or directly at the casing regions.

10. The decoupling device according to claim 5 wherein fixing device comprises a fastener.

11. The decoupling device according to claim 10 wherein the fastener comprises a bolt.

12. The decupling device according to claim 1 wherein the stop geometry comprises multiple stops for limiting maximum oscillations permitted for the damping arrangement, due to vibrations or movements or both of the component.
